(19) United States
(12) Patent Application Publication
(10) Pub. No.: US 2006/0025164 A1
(43) Pub. Date: Feb. 2, 2006

(54) Method and system for integrating instant message into unified message

(75) Inventors: Richard Gaohua Wang, Bradenton, FL (US); Disheng Zhang, Shenzhen (CN)

Correspondence Address: RICHARD G. H. WANG, 1903 60TH PLACE, SUITE M1145, BRADENTON, FL, 34203, US

(73) Assignees: Richard Gaohua Wang, Bradenton, FL (US); Disheng Zhang, Shenzhen (CN)

(21) Appl. No.: 10/904,112

(22) Filed: Oct. 25, 2004

Related U.S. Application Data
(63) Continuation of application No. 10/710,746, filed on Jul. 30, 2004.

(51) Int. Cl. H04Q 7/20

(52) U.S. Cl. 455/466

(57) ABSTRACT

A method, system, means, and computer program code for integrating instant message into unified message service. According to embodiments of the present invention, each unified message user not only have a unique phone number for its unified message service, but also have a corresponding HTTP URL for its instant message service and messages management center. Caller that call user's unified message number can leave message, send fax and call forward to any phone number or Internet-connected computer with microphone and speaker (Phone to PC). User can use telephone to listen its voice message, text message by text-to-speech and use fax machine to retrieve and send fax/email and also can use computer to check its voice message, text message, email, fax as well as to send fax and SMS. Anyone can access the user's URL for Instant Message in any Internet browser, if the user is online, then they can chat to each other. If the user is offline, then the people can leave text or voice message to the user or choose to call the user's unified message phone number (PC to Phone), then the unified message system can route to leave message or send fax or call forward to any phone number based on user's predefined rules.

### CROSS REFERENCE TO RELATED APPLICATION

This application claims priority from U.S. Nonprovisional application Ser. No. 10/710,746 filed on Jul. 30, 2004, which is hereby incorporated into the present application by reference.

### FIELD OF THE INVENTION

The present invention relates to methods and system for integrating instant message into unified message and, more particularly, embodiments of the present invention relate to methods, means, system, and computer program code and communication network for providing instant message service and unified message service.

### BACKGROUND OF THE INVENTION

Today, we have many ways in order to contact another person. Unfortunately, all these methods sit in smokestacks, with very little crossover from one medium to the other. Instant message is becoming the primary means of communications for many people, but it is mostly PC-to-PC communication with Internet-connected. Unified message is also very popular in the last decade, but it is Phone-to-Phone or Phone-to-Email communication, and it is not a real time person-to-person communication, it is a one-way retrieval interaction—machine to person interaction. Therefore, a solution is needed to integrate instant message and unified message to communicate in real time using any device (PC, phone, mobile phone etc.), any time, anywhere. And we also need a central place to manage all messages from instant message, unified message and email.

It would be a revolution to provide a new method and system that overcomes the drawbacks described in the above paragraphs. In particular, this invention is aim to integrate instant message into unified message to allow people communicate in real time, using PC and phone with wireless capabilities delivering anytime, anywhere, any device.

### SUMMARY OF THE INVENTION

Embodiments of the present invention provide a system, method, means and computer program code that integrate instant message into unified message, people can use any device to communicate with others using any device.

Additional advantages and novel features of the invention shall be set forth in part in the description that follows, and in part will become apparent to those skilled in the art upon examination of the following or may be learned by the practice of the invention.

According to some embodiments of the present invention, each unified message user not only have a unique phone number for its unified message service, but also have a corresponding HTTP URL for its instant message service and messages management center. Caller that call user's unified message number can leave message, send fax and call forward to any phone number or Internet-connected computer with microphone and speaker (Phone to PC). User can use telephone to listen to its voice message, text message by text-to-speech and use fax machine to retrieve and send fax/email and also can use computer to check its voice message, text message, email, fax image file, send fax and SMS. Anyone can access the user's URL for Instant Message in any Internet browser, if the user is online, then they can chat to each other. If the user is offline, then the people can leave text or voice message to the user or choose to call the user's unified message phone number (PC to Phone), then the unified message system can route to leave message or send fax or call forward to any phone number based on user's predefined rules.

According to some embodiments of the present invention, enterprise user can setup its contact center using present invention, enterprise user can use the unified message system as its virtual PBX, the auto-operator system will route the call to predefined department phone number or online PC with microphone and speaker or IP phone, and can use the URL for Instant Message for online live help for its customer, the operator or auto-operator will route the online chat to predefined person or route to unified message number. If the URL for Instant Message is offline, the instant message sender can leave message or connect to its unified message number to talk to. Enterprise user can define the security control rule and policy for instant message and unified message to secure instant message and unified message for business.

According to some embodiments of the present invention, personal user can use the unified number as permanent contact number that can route the call to his/her home number, work number, mobile number or online PC with microphone and speaker or IP phone. And personal user can use its corresponding URL for Instant Message to communicate with others and manage its messages including voice mail, fax image, text message, email etc. When the user is online, the calling from its unified message number can route to its online PC. When the user is offline, the instant message sender can leave message or connect to its unified message number to talk to. Personal user can setup and receive all kind of alerts and remote control home appliance and security monitor system.

With these and other advantages and features of the invention that will become hereinafter apparent, the nature of the invention may be more clearly understood by reference to the following detailed description of the invention, and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a block diagram of system components for unified message system that integrate with instant message in accordance with the present invention.

FIG. 2 is a flowchart of a first embodiment of a method of integrating instant message with unified message in accordance with the present invention.

### DETAILED DESCRIPTION

Applicant has recognized that there is a need for systems, means, computer program code and methods that process unified message and instant message service. The key factor for this invention is that each unified message user will have a phone number like (813)354-3669 for its unified message service, and he/she will also have a phone number corresponding HTTP URL like “8133543669.com” for its instant message unique user identifier (UID), this URL called URL for Instant Message. Any one can access this URL for Instant Message in any browser to contact the user using PC or call the user's unified message phone number to contact the user. These and other features will be discussed in further detail below, by describing a system and processes according to embodiments of the invention.

System

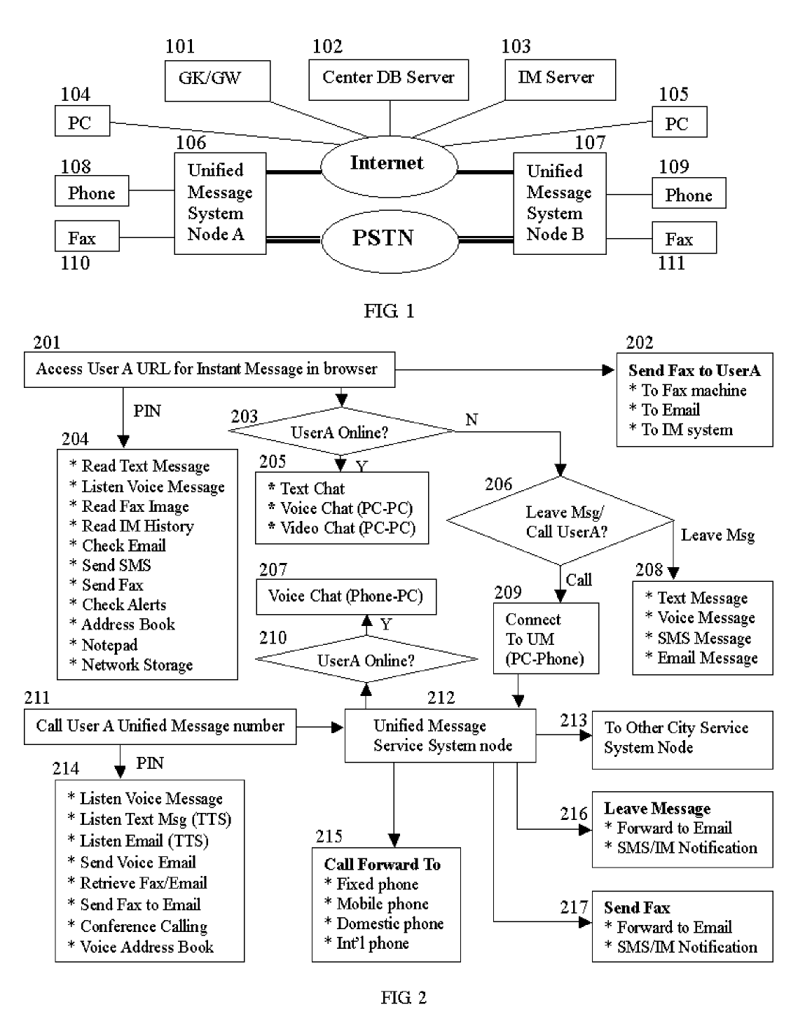

Now referring to FIG. 1, a system usable with the methods disclosed herein is illustrated. The apparatus 106/107 (Unified Message System Platform) may include one or more devices that may communicate directly or indirectly with one or more servers, controllers or other devices or other communications network.

User can use devices like PC (104/105), fixed phone and mobile phone (108/109), fax machine (110/111) to interact with each other using unified message and instant message system. Device 101 (GK) is for Voice over IP communication between two or more unified message system node, and 101 (GW) is the Voice Over IP gateway for initial a call from PC to Phone and form Phone to PC. Server 102 is the center database server for user authentication, user online status management, user's message management center and other related functions. 103(IM server) is the server for providing instant message service. 106/107 should connect to Internet and PSTN network.

Although three user devices 104, 108, 110 and three servers 101, 102, 103 are shown in FIG. 1, any number of such devices may be included in the system. Many different types of implementations or hardware/software configurations can be used in the system and its components and with the methods disclosed herein, and the methods disclosed herein are not limited to any specific hardware/software configuration for the system or any of its components. These and other features will be discussed in further detail below, by describing a system and processes according to embodiments of the invention.

Process Description

Reference is now made to FIG. 2, where a flow chart is shown which represents an operation of a first embodiment of the present invention. The particular arrangement of elements in the flow chart is not meant to imply a fixed order to the steps; embodiments of the present invention can be practiced in any order that is practicable. In some embodiments, the process method is particularly well suited for implementation by or on a personal user and an enterprise user, as will be discussed in more detail below.

When some one calls User A's unified message number (211), it will connect to unified message service system (212), 212 will check if User A's URL for Instant Message is registered online (210), if User A is online, then 212 will tell User A some one is calling his/her unified number and if he/she like to speak with the caller in online PC with microphone and speaker, if User A say “yes”, then 212 route the call to User A's PC for phone-to-pc conversation (voice chat) (207), if User A say “No”, then 212 route the call to predefined phone number or ask the caller press “1” (system could define any other number) to leave message (216), and 212 will process the voice mail and forward to User A's email account and send SMS notification to User A's mobile phone or send instant message notification to User A based on User A's predefined notification rules. Or ask the caller press “2” to send fax (217), then 212 will give the fax response tone to the caller and process the fax to image file and forward to User A's email account and send SMS notification to User A's mobile phone or send instant message notification to User A based on User A's predefined notification rules. Or ask the caller press “3” to forward the calling to another phone number (215), 212 will forward to User's work or home fixed phone or mobile phone or domestic long distance phone or international long distance phone based on User A's predefined rule, and if the call forward long distance phone number is the same service provider's another city service node number or the service provider have service node in the call forward long distance phone number city, then route the call to the service provider's another city service system node using VoIP technology to save user's cost. User A can change all predefined rules at any time when he/she login its message management center.

User A can call its own unified message number and input its PIN (Personal Identification Number) to manage its unified message (214) that can listen all voice message, and listen text message, email message by text-to-speech technology, and can send voice message to email system following the system instruction, 212 will send the voice message to destination email account. User A can use the fax machine to retrieve the received fax at any time any fax machine and send fax to email system following the system instruction, 212 will send the fax image file to destination email account. User also can setup a conference call and invite other unified message number user or any other phone number user to join an audio conference. User also can call its own unified message number to let the system 212 to help to connect to some one that listed in the voice address book by using speech recognition technology, user only need to say “connect to Jason”, the system 212 will find Jason's phone number and place the call.

When some one (User B) access User A's URL for Instant Message in any browser (201), it will display a web page to indicate User A's online status (203), if User A is online, then User B can chat with User A by text or voice if the party's PC have microphone and speaker or video if the party's PC have a camera. Since this instant message solution is based on our previous U.S. nonprovisional application—Method and System for Instant Message using HTTP Technology (application Ser. No. 10/710,746, filed on Jul. 30, 2004), there is no necessary to describe the process for instant message. And if User A is offline, then system will ask User B if he/she want to leave message to User A or call User A (206), if User B choose to leave message (208), then User B can leave text message, voice message, SMS message and email message, the system will send the message to predefined destination. If User B choose to call User A, then system can route to unified message system to call User A's predefined phone number (209). The next process is described in above section only no necessary to check if User A is online, and this is a PC-to-phone process.

User A can access his/her own URL for Instant Message from any browser and enter its PIN to login and stay in online status, and this also means User A login its message management center (204), User A can manage all his/her messages, read text message, fax image, instant message history and email, listen to the voice message, send fax and SMS, check all kind of alerts, check and manage its notepad and address book, manage its network storage file.

Any one that access User A's URL for Instant Message from any browser can send fax to User A using PC based on User A's predefined rule (202), no matter User A is online or offline, system will route the fax to traditional fax machine (PC to Fax) or to User A's email account or to User A's instant message management system according to User A's predefined rule.

For enterprise application, enterprise user can use present invention to setup its own contact center, we named it as CorCenter (Corporate Contact Center), enterprise user can use the unified message system as its virtual PBX (Private Branch telephone exchange), when some one call enterprise user's unified message number, he/she will hear a customized greeting message and instruct the caller to press proper number to connect to appropriate department. The auto-operator system will route the call to predefined department phone number or online PC with microphone and speaker or IP phone. And enterprise user can use the URL for Instant Message for online live help for its customer, the operator or auto-operator will route the online chat to predefined proper person or route to unified message number. If the enterprise live-help operator's URL for Instant Message is offline, the instant message sender can leave message or connect to its unified message number to talk to. Enterprise user can define the security control rule and policy for instant message and unified message to secure instant message and unified message for business such as file transfer rule, content filtering rule, sub-domain restrict rule, blacklist, user group and authentication, SPAM and virus protection. The system also provides full data audit, statistic and search function. All historical instant messages are saved in its message management center.

For personal application, personal user can use the unified number as permanent contact number that can route the call to his/her home number, work number, mobile number or online PC with microphone and speaker or IP phone. And personal user can use its corresponding URL for Instant Message to communicate with others and manage all of its messages including voice mail, fax image, text message, email etc. When the personal user is online, the calling from its unified message number can route to its online PC, when the user is offline, the instant message sender can leave message or connect to its unified message number to talk to. And personal user can setup and receive alerts like memo, bank account, stock change, foreign exchange rate change, traffic incident, sport scores, breaking news, weather forecast, special offer from shop etc. and remote control online home appliance and security monitor system. And personal user can setup and receive the alert of all personal property lost or stolen or fire by some special interface device connected to those properties and even send alerts to the appropriate emergence services. And personal user can use its URL for Instant Message as a Internet passport to login to many membership-based website to manage all other web-based application.

Unified message service provider can setup many service nodes in different city, the call between the node city can go through Internet using Voice Over IP technology to save call cost. And service provider also can provide web call service using this invention solution.

The methods of the present invention may be embodied as a solution for integrating instant message into unified message to provide unified instant communication to let user use PC, fixed phone, mobile phone to communicate with each other more conveniently and more easily, Also by combining the Internet-base communication with telephone network-based communication to let people communication at any time, anywhere using any device. However, it would be understood that the invention as described herein could be implemented in many different ways for other application. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single system, multi-system, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

What is claimed is:

1. A method for integrating instant message into unified message, comprising: Each unified message user not only have a unique phone number for its unified message service, but also have a corresponding HTTP URL for its instant message service and its message management center. User can be reached by phone call or instant message, and can manage its unified message, instant message and email by phone and PC.

2. The method of claim 1, wherein said the unified message user not only have a unique phone number for its unified message service, but also have a corresponding HTTP URL for its instant message service and its messages management center.

3. The method of claim 1, wherein said Caller that call user's unified message number can leave voice message, send fax and call forward to any phone number or Internet-connected computer with microphone and speaker (Phone to PC) when user is online based on user's predefined rules.

4. The method of claim 1, wherein said user can call its own unified message number to listen its voice message, text message using text-to-speech technology, setup a audio conference call and voice call some one that in the voice address book using speech recognition technology. User can use fax machine to retrieve and send fax/email, and also can use computer to check its voice message, text message, email, fax, and send fax and SMS.

5. The method of claim 1, wherein said every unified message user can also have a corresponding HTTP URL for its instant message service. If the user is online, anyone can access the user's URL for Instant Message in the browser to chat with him/her (text/voice/video). Both party do not need to install any instant message client software. If user is offline, the caller can leave text/voice message or connect to the user's unified message number to leave voice message or redirect to any other phone number based on predefined rule.

6. The method of claim 1, wherein said the user can access its own URL for Instant Message to manage his/her messages, read text message, fax image, instant message history and email, listen to the voice message, send fax and SMS, check all kind of alerts, check and manage its notepad and address book, manage its network storage file.

7. The method of claim 1, wherein said the voice communication between two unified message system node can use Voice over IP technology to save user's communication cost.

8. The method of claim 1, wherein said user can use a special USB flash disk drive device to login to its message management center by plugging the device into PC USB interface. All messages including voice message, fax image, text message, email etc. can be downloaded to the USB device for local and portable review and check.

9. A method for deploying unified message with instant message service for enterprise user, comprising: enterprise user can setup its contact center using this solution, enterprise user can use the unified message system as its virtual PBX, the auto-operator system will route to predefined department phone number or online PC with microphone and speaker or IP phone, and can use the URL for Instant Message for online live help for its customer, the operator or auto-operator will route the online chat to predefined person or route to unified message number. If the URL for Instant Message is offline, the instant message sender can leave message or connect to its unified message number. Enterprise user also can define the security control rule and policy for instant message and unified message to secure instant message and unified message for business.

10. The method of claim 9, wherein said enterprise user can use the unified message system as its virtual PBX, anyone call its unified message number, it will hear a customized greeting to instruct the caller press the department extension number to contact to the appropriate department. The system will route to any predefined local fixed or mobile phone number or domestic or international phone number or online PC with microphone and speaker or IP phone.

11. The method of claim 9, wherein said enterprise user can use the URL for Instant Message for online live help for its customer, the live help operator or auto-operator will route the online chat to predefined person or route to unified message number. If the enterprise users embed the URL for Instant Message in its website, any website visitor can click this URL's hyperlink to get live help. And if the URL for Instant Message is offline, the instant message sender can leave message or connect to its unified message number.

12. The method of claim 9, wherein said all unified message number calling history, voice message and instant message history will classify to its message management center, enterprise user can login its URL for Instant Message to manage those customer information as customer relationship management (CRM) to serve its customer better.

13. The method of claim 9, wherein said enterprise user can define the security control rule and policy for instant message and unified message such as file transfer rule, content filtering rule, sub-domain restrict rule, blacklist, user group and authentication, SPAM and virus protection. The system also provides full data audit, statistic and search function. All historical instant messages are saved in its message management center.

14. A method for deploying unified message with instant message service for personal user, comprising: personal user can use the unified number as permanent contact number that can route the call to his/her home number, work number, mobile number or online PC with microphone and speaker or IP phone. And personal user can use its corresponding URL for Instant Message to communicate with others and manage all messages including voice mail, fax image, text message, email etc. When the personal user is online, the calling from its unified message number can route to its online PC, when the user is offline, the instant message sender can leave message or connect to user's unified message number to talk to. And personal user can setup and receive all kind of alerts and remote control home appliance and security monitor system.

15. The method of claim 14, wherein said personal user can predefine the rule for routing its unified number to any available number and can route the call to online PC (Phone to PC) or IP phone.

16. The method of claim 14, wherein said personal user can use its unified message number corresponding URL for Instant Message to communicate with others and manage its all message including voice mail, fax image, text message, email etc when login its URL for Instant Message. If the user is offline, the instant message sender can leave message or connect to its unified message number to talk to (PC to Phone).

17. The method of claim 14, wherein said when personal user login his/her URL for Instant Message, he/she can remote control its Internet-connected home appliance and security monitor system.

18. The method of claim 14, wherein said when personal user login his/her URL for Instant Message, he/she can setup and receive all kind of alerts like memo, bank account, stock change, foreign exchange rate change, traffic incident, sport scores, breaking news, weather forecast, special offer from shop etc.

19. The method of claim 14, wherein said when personal user login his/her URL for Instant Message, he/she can setup and receive the alert of all personal property lost or stolen or fire by some special interface device connected to those properties and even send alerts to the appropriate emergence services.

20. The method of claim 14, wherein said personal user can use its URL for Instant Message as a Internet passport to login to many membership-based website to manage all other web-based application.
